(19) United States
(12) Patent Application Publication
(10) Pub. No.: US 2026/0265446 A1
(43) Pub. Date: Sep. 10, 2026

(54) CURABLE RESIN AND METHODS FOR PRODUCING CURABLE RESIN INTERMEDIATE, CURABLE RESIN, CURABLE RESIN COMPOSITION, AND CURED PRODUCT

(71) Applicant: NIPPON SHOKUBAI CO., LTD., Osaka (JP)

(72) Inventors: Nobuaki OTSUKI, Osaka (JP); Yasuhiro MATSUDA, Osaka (JP)

(73) Assignee: NIPPON SHOKUBAI CO., LTD., Osaka (JP)

(21) Appl. No.: 18/875,984

(22) PCT Filed: May 15, 2023
(86) PCT No.: PCT/JP2023/018148

§ 371 Date: Dec. 17, 2024

(30) Foreign Application Priority Data
Jul. 6, 2022 (JP) 2022-109176

(51) Int. Cl. C08G 59/02; C08F 2/50; C08F 290/14; C08G 59/17; C08G 59/68

(52) U.S. Cl. CPC C08G 59/022; C08F 2/50; C08F 290/144; C08G 59/1466; C08G 59/688

(57) ABSTRACT

An object of the present disclosure is to provide a curable resin capable of providing a cured product having excellent adhesion and thermal shock resistance, a method for producing an intermediate from which the curable resin can be synthesized, and a method for producing the curable resin. A method for producing a curable resin intermediate, the method including reacting an epoxy resin having a polydispersity (Mw/Mn) of 2.8 or more with an unsaturated monobasic acid in the presence of benzene or naphthalene with two or more directly bonded hydroxy groups.

### TECHNICAL FIELD

The present disclosure relates to a curable resin that can be used for image formation applications and the like; a method for producing an intermediate from which the curable resin can be synthesized and a method for producing the curable resin; and methods for producing a curable resin composition containing the curable resin and a cured product of the curable resin composition.

### BACKGROUND ART

Epoxy acrylate, which is obtained by modifying an epoxy resin with an unsaturated monobasic acid, can be cured by heat or light into a cured product with excellent properties, such as chemical resistance, and thus is used as a curable resin in various molding materials and coating applications. Epoxy acrylate is also widely used as a photocurable resin for fine processing and image formation. In this field, there is a demand for a resin material to which principles of photographic methods can be applied to produce finer images and also which can be developed in a diluted weak alkaline aqueous solution for environmental protection. From such viewpoints, a carboxyl group-containing epoxy acrylate, which is obtained by reacting epoxy acrylate with a polybasic acid anhydride to introduce a carboxyl group, or the like has been used (e.g., Patent Documents 1-4, etc.).

In pattern formation with a photocurable resin, a series of steps is employed, in which a curable resin is applied onto a substrate, heated and dried to form a coating film, and then a patterning film is pressed onto this coating film, exposed to light, and developed. In a series of these steps, good developability and high resolution for forming a fine pattern, or tack-free properties of the curable resin related to peeling properties of the patterning film after exposure to light and development are required, and various studies have been conducted. In addition, in recent years, a cured product after curing a curable resin has also been required to have high durability and to have thermal shock resistance and adhesion as heat resistance and environment resistance capable of withstanding a treatment step at high temperature (e.g., such as soldering in a solder resist and ITO film formation on a color filter substrate).

### RELATED ART DOCUMENTS

### Patent Documents

Patent Document 1: JP 61-243869 A
Patent Document 2: JP 63-258975 A
Patent Document 3: JP 11-222514 A
Patent Document 4: JP 2000-109541 A

### SUMMARY OF THE INVENTION

### Problems to be Solved by the Invention

The present disclosure has been made in view of the above circumstances, and an object of the present disclosure is to provide a curable resin capable of providing a cured product having excellent adhesion and excellent thermal shock resistance, a method for producing an intermediate from which the curable resin can be synthesized, and a method for producing the curable resin.

### Solutions to the Problems

As a result of diligent studies to solve the object, the present inventors have found that producing a curable resin intermediate by a method including reacting an epoxy resin having a polydispersity (Mw/Mn) of 2.8 or more with an unsaturated monobasic acid in the presence of benzene or naphthalene with two or more directly bonded hydroxy groups allows a cured product obtained from a curable resin synthesized from the curable resin intermediate to have excellent adhesion and excellent thermal cycle test resistance (TCT resistance), that is, excellent thermal shock resistance, and completed the present disclosure.

That is, the present disclosure is specified by the following constitution requirements.
[1] A method for producing a curable resin intermediate, the method including reacting an epoxy resin having a polydispersity (Mw/Mn) of 2.8 or more with an unsaturated monobasic acid in the presence of benzene or naphthalene with two or more directly bonded hydroxy groups.
[2] The production method according to [1], in which the epoxy resin is a cresol novolac type epoxy resin.
[3] The production method according to [1] or [2], in which the epoxy resin has a weight-average molecular weight of 3000 or more, a softening point of 85 to 110° C., and an epoxy equivalent of 150 to 300 g/eq.
[4] The production method according to any of [1] to [3], in which in the reacting the epoxy resin with the unsaturated monobasic acid, the epoxy resin is also reacted with a phenolic compound having an alcoholic hydroxyl group.
[5] A method for producing a curable resin, the method including producing a curable resin intermediate by the method described in any of [1] to [4], and then reacting the resulting curable resin intermediate with a polybasic acid anhydride.
[6] The production method according to [5], in which the curable resin has a double bond equivalent of 300 to 620 g/eq.
[7] The production method according to [5] or [6], in which the curable resin has an acid value of 50 to 100 mg KOH/g.
[8] A method for producing a curable resin composition, the method including producing a curable resin by the production method described in any of [5] to [7], and then blending the resulting curable resin and a polymerization initiator, and as necessary a monomer.
[9] A method for producing a cured product, the method including producing a curable resin composition by the production method described in [8], and then curing the resulting curable resin composition.
[10] A curable resin containing:
an epoxy resin-derived moiety having a structure in which an epoxy group of the epoxy resin is ring-opened;
an unsaturated monobasic acid residue bonded to a carbon atom of the ring-opened moiety derived from the epoxy group; and
a polybasic acid anhydride residue bonded to an oxygen atom of the ring-opened moiety derived from the epoxy group, in which
the epoxy resin-derived moiety has a polydispersity (Mw/Mn) of 2.8 or more, and
the curable resin contains benzene or naphthalene with two or more directly bonded hydroxy groups.

### Effects of the Invention

The curable resin intermediate according to an embodiment of the present disclosure is produced by reacting an epoxy resin with an unsaturated monobasic acid in the presence of benzene or naphthalene with two or more directly bonded hydroxy groups and using an epoxy resin having a polydispersity (Mw/Mn) of 2.8 or more as the epoxy resin. Thus, the curable resin intermediate according to an embodiment of the present disclosure and the curable resin synthesized from the intermediate can provide a cured product having excellent adhesion and further having excellent thermal cycle test resistance (TCT resistance), that is, excellent thermal shock resistance, as being less likely to crack even though a thermal history of high temperature and low temperature is repeatedly applied.

### DESCRIPTION OF EMBODIMENTS

### 1. Curable Resin Intermediate

In an embodiment of the present disclosure, a curable resin intermediate is obtained by a production method including reacting an epoxy resin having a polydispersity (Mw/Mn) of 2.8 or more with an unsaturated monobasic acid in the presence of benzene or naphthalene with two or more directly bonded hydroxy groups. According to the method for producing a curable resin intermediate according to an embodiment of the present disclosure, a radically polymerizable double bond can be introduced into the structure by reacting an epoxy resin with an unsaturated monobasic acid. Using the curable resin intermediate makes it possible to provide a curable resin capable of forming a cured product with excellent adhesion and excellent TCT resistance. In addition, the cured product preferably also has excellent developability and tack-free properties. The curable resin intermediate may be used as it is as a curable resin (e.g., as epoxy (meth)acrylate or the like) without being reacted with a polybasic acid anhydride, but the curable resin intermediate is preferably reacted with a polybasic acid anhydride and used as a curable resin (e.g., as a carboxyl group-containing epoxy (meth)acrylate or the like).

In the production of the curable resin intermediate, an epoxy resin having a polydispersity (Mw/Mn) of 2.8 or more is used. The epoxy resin is not particularly limited as long as it is a compound having two or more epoxy groups per molecule and having a polydispersity (Mw/Mn) of 2.8 or more, and a known epoxy resin can be used.

The polydispersity (Mw/Mn) of the epoxy resin can be determined by gel permeation chromatography (GPC).

Examples of the epoxy resin include a bisphenol epoxy resin, such as a bisphenol A epoxy resin and a bisphenol F epoxy resin; a novolac type epoxy resin, such as a phenol novolac type epoxy resin, a cresol novolac type epoxy resin, and a naphthalene-containing novolac type epoxy resin; a triphenolmethane type epoxy resin, a dicyclopentadiene type epoxy resin; a biphenyl type epoxy resin; an alicyclic epoxy resin; a glycidylamine type epoxy resin; a glycidyl ester type epoxy resin; a reaction product of a polyphenol compound with epichlorohydrin, the polyphenol compound being obtained by condensation reaction of a phenolic compound, such as phenol, o-cresol, m-cresol, or naphthol, with an aromatic aldehyde having a phenolic hydroxyl group; and a reaction product of a polyphenol compound with epichlorohydrin, the polyphenol compound being obtained by addition reaction of a phenolic compound with a diolefin compound, such as divinylbenzene or dicyclopentadiene. In addition, two or more molecules of these epoxy resins may be bonded by reaction with a chain extender, such as a polybasic acid, a polyphenol compound, a polyfunctional amino compound, or a polyvalent thiol, to extend the chain, and a chain-extended epoxy resin thus obtained may be used.

The epoxy resin is preferably a novolac type epoxy resin or a triphenolmethane type epoxy resin and more preferably a novolac type epoxy resin. The novolac type epoxy resin is preferably a phenol novolac type epoxy resin or a cresol novolac type epoxy resin and more preferably a cresol novolac type epoxy resin. The cresol novolac type epoxy resin may be any of an o-cresol novolac type epoxy resin (hereinafter also referred to as an ortho-cresol novolac type epoxy resin), an m-cresol novolac type epoxy resin, and a p-cresol novolac type epoxy resin and is preferably an o-cresol novolac type epoxy resin. In the case of using a cresol novolac type epoxy resin, the cresol novolac type epoxy resin is used as at least a part of the epoxy resin. Using a cresol novolac type epoxy resin can increase the heat resistance of a cured product formed from the curable resin obtained from the curable resin intermediate. As the cresol novolac type epoxy resin, a known cresol novolac type epoxy resin can be used. For example, it can be produced by reaction of cresol with epichlorohydrin.

In an embodiment of the present disclosure, a cresol novolac type epoxy resin having a polydispersity (Mw/Mn) of 2.8 or more is preferably used so that it is a main component of the epoxy resin. “Used as a main component of the epoxy resin” means using more than 50 mass % per 100 mass % of the total epoxy resin. The amount of the cresol novolac type epoxy resin having a polydispersity (Mw/Mn) of 2.8 or more to be used is preferably 80 mass % or more, more preferably 90 mass % or more, even more preferably 95 mass % or more per 100 mass % of the total epoxy resin, and it is particularly preferred to use substantially only the cresol novolac type epoxy resin having a polydispersity (Mw/Mn) of 2.8 or more as the epoxy resin.

Specific examples of the cresol novolac type epoxy resin having a polydispersity (Mw/Mn) of 2.8 or more that can be used include a cresol novolac type epoxy resin YDCN-704A available from NIPPON STEEL Chemical & Material Co., Ltd.

Producing the curable resin intermediate using the epoxy resin having a polydispersity (Mw/Mn) of 2.8 or more allows a cured product obtained from a curable resin synthesized from the curable resin intermediate to have excellent developability and adhesion and to have excellent TCT resistance, that is, excellent thermal shock resistance, as being less likely to crack even though a thermal history of high temperature and low temperature is repeatedly applied.

The polydispersity (Mw/Mn) of the epoxy resin is preferably 2.83 or more and more preferably 2.85 or more. On the other hand, the upper limit of the polydispersity (Mw/Mn) of the epoxy resin is not particularly limited and is preferably 3.5 or less from the viewpoint of handleability. That is, the polydispersity (Mw/Mn) of the epoxy resin is preferably from 2.83 to 3.5 and more preferably from 2.85 to 3.5. In the case of using a cresol novolac type epoxy resin as the epoxy resin, the polydispersity (Mw/Mn) is even more preferably 3.3 or less, still more preferably 3.25 or less, and yet more preferably 3.2 or less. That is, the polydispersity (Mw/Mn) in the case of using a cresol novolac type epoxy resin as the epoxy resin is preferably from 2.83 to 3.5, more preferably from 2.85 to 3.5, even more preferably from 2.85 to 3.3, still more preferably from 2.85 to 3.25, and yet more preferably from 2.85 to 3.2. Using a cresol novolac type epoxy resin having a polydispersity (Mw/Mn) of 3.3 or less makes it easier to obtain a curable resin with excellent tack-free properties and/or developability.

From the viewpoint of further increasing the thermal shock resistance, the softening point of the epoxy resin is preferably 85° C. or higher and more preferably 89° C. or higher. In the case of using a cresol novolac type epoxy resin as the epoxy resin, the softening point is preferably 85° C. or higher, more preferably 87° C. or higher, even more preferably 89° C. or higher, still more preferably 89.5° C. or higher, yet more preferably 90° C. or higher, and still even more preferably 90.5° C. or higher. With a higher softening point, a cured product with even better tack-free properties and thermal shock resistance is obtained. On the other hand, the upper limit of the softening point of the epoxy resin is not particularly limited and is preferably 110° C. or lower from the viewpoint of handleability. In the case of using a cresol novolac type epoxy resin as the epoxy resin, the softening point is more preferably 103° C. or lower, even more preferably 102.5° C. or lower, and still more preferably 102° C. or lower. That is, the softening point of the epoxy resin is preferably from 85 to 110° C. and more preferably from 89 to 110° C. In addition, the softening point in the case of using a cresol novolac type epoxy resin as the epoxy resin is preferably from 85 to 110° C., more preferably from 87 to 103° C., even more preferably from 89 to 102.5° C., still more preferably from 89.5 to 102° C., yet more preferably from 90 to 102° C., and still even more preferably from 90.5 to 102° C. Using a cresol novolac type epoxy resin having a softening point of 103° or lower makes it easier to obtain a curable resin with excellent developability. In addition, the polydispersity (Mw/Mn) of the epoxy resin is 2.8 or more, and thus even with a softening point of the epoxy resin of 96° C. or lower, a cured product formed can have sufficient thermal shock resistance.

The softening point of the epoxy resin can be determined according to JIS K 7234 (1986).

The weight-average molecular weight (Mw) of the epoxy resin is preferably 3000 or more. In the case of using a cresol novolac type epoxy resin as the epoxy resin, the weight-average molecular weight (Mw) is more preferably 3100 or more, even more preferably 3300 or more, and still more preferably 3650 or more. On the other hand, the upper limit of the weight-average molecular weight (Mw) of the epoxy resin is not particularly limited and is preferably 15000 or less from the viewpoint of handleability. In the case of using a cresol novolac type epoxy resin as the epoxy resin, the weight-average molecular weight (Mw) is more preferably 10000 or less, even more preferably 8000 or less, and still more preferably 6000 or less. That is, the weight-average molecular weight (Mw) of the epoxy resin is preferably from 3000 to 15000. In addition, in the case of using a cresol novolac type epoxy resin as the epoxy resin, the weight-average molecular weight (Mw) is preferably from 3000 to 15000, more preferably from 3100 to 10000, even more preferably from 3300 to 8000, and still more preferably from 3650 to 6000.

The weight-average molecular weight (Mw) of the epoxy resin can be determined by gel permeation chromatography (GPC).

The epoxy equivalent of the epoxy resin is preferably from 150 to 300 g/eq., more preferably from 160 to 270 g % eq., and even more preferably from 170 to 250 g/eq.

The epoxy equivalent of the epoxy resin can be determined according to JIS K 7236 (2001).

The unsaturated monobasic acid used in the production of the curable resin intermediate is a compound having one acid group and one or more radically polymerizable unsaturated bonds per molecule. Examples of the acid group include a carboxyl group, a sulfonate group, and a phosphate group, and a carboxyl group is preferred. Reacting the unsaturated monobasic acid with the epoxy resin allows the acid group of the unsaturated monobasic acid to react with an epoxy group of the epoxy resin and can introduce the radically polymerizable double bond into the epoxy resin.

Examples of the unsaturated monobasic acid include acrylic acid, methacrylic acid, crotonic acid, cinnamic acid, (3-acryloxypropionic acid, a reaction product of a hydroxyalkyl (meth)acrylate having one hydroxyl group and one (meth)acryloyl group with a dibasic acid anhydride, a reaction product of a polyfunctional (meth)acrylate having one hydroxyl group and two or more (meth)acryloyl groups with a dibasic acid anhydride, and caprolactone-modified products of these monobasic acids. One of these unsaturated monobasic acids or two or more can be used. Among these, an alkenylcarboxylic acid is preferably used, and acrylic acid or methacrylic acid is more preferably used.

In reacting the epoxy resin with the unsaturated monobasic acid in the presence of benzene or naphthalene with two or more directly bonded hydroxy groups, the epoxy resin may be further reacted with a phenolic compound having an alcoholic hydroxyl group (hereinafter also referred to as the “phenolic compound A”). Reacting a phenolic compound having an alcoholic hydroxyl group can introduce an alcoholic hydroxyl group into the curable resin intermediate via a phenoxy unit. The introduced alcoholic hydroxyl group has less steric hindrance than a hydroxyl group formed by ring-opening of an epoxy group contained in an epoxy resin in a production process of a curable resin described later. Thus, a polybasic acid anhydride preferentially reacts with the alcoholic hydroxyl group. The curable resin synthesized from the curable resin intermediate obtained by reacting not only an unsaturated monobasic acid but also the phenolic compound A with the epoxy resin can produce a cured product with further improved adhesion and TCT resistance.

The phenolic compound having an alcoholic hydroxyl group means an aromatic ring compound having an alcoholic hydroxyl group and a phenolic hydroxyl group. The phenolic hydroxyl group means a hydroxy group directly bonded to the aromatic ring, and the aromatic ring is preferably an aromatic hydrocarbon ring, such as a benzene ring or a naphthalene ring, and may be an aromatic heterocycle. A hydroxy group directly bonded to an aromatic ring exhibits strong acidity like phenol and is classified as a phenolic hydroxy group. On the other hand, the alcoholic hydroxyl group is indirectly bonded to the aromatic ring. These two hydroxyl groups differ in their reactivity with the epoxy group of the epoxy resin; the phenolic hydroxyl group reacts preferentially with the epoxy group, and the alcoholic hydroxyl group remains unreacted. Thus, when the curable resin intermediate is then mixed with a polybasic acid anhydride, the remaining alcoholic hydroxyl group reacts with the polybasic acid anhydride. The phenolic compound having an alcoholic hydroxyl group may have a plurality of alcoholic hydroxyl groups and/or a plurality of phenolic hydroxyl groups and may further have an additional substituent (e.g., such as an alkyl group, an alkoxy group, an aryl group, an aryloxy group, an acyl group, an alkoxycarbonyl group, and/or an aryloxycarbonyl group).

The alcoholic hydroxyl group is indirectly bonded to the aromatic ring as described above. Examples of the group present between the aromatic ring and the alcoholic hydroxyl group include an alkylene group having from 1 to 10 carbons, such as a methylene group and an ethylene group; a group obtained by combining a —C(═O)O— group and one or two alkylene groups having from 1 to 10 carbons; a group obtained by combining a —O— group and one or two alkylene groups having from 1 to 10 carbons; and a group obtained by combining a divalent aromatic ring, such as a phenylene group, an —O— group, and an alkylene group. In all the examples, the alcoholic hydroxyl group is preferably bonded to an alkylene group.

Examples of the phenolic compound having an alcoholic hydroxyl group include a hydroxyalkylphenol, such as p-hydroxyphenyl-2-ethanol, p-hydroxyphenyl-3-propanol, p-hydroxyphenyl-4-butanol, (bis)hydroxymethylphenol, and hydroxymethyl-di-t-butylphenol; a hydroxyalkyl cresol, such as (bis)hydroxymethyl cresol and hydroxyethyl cresol; an esterification product of a carboxyl group-containing phenolic compound, such as hydroxybenzoic acid, hydroxyphenylbenzoic acid, or hydroxyphenoxybenzoic acid, with ethylene glycol, propylene glycol, glycerol, or the like; a monoethylene oxide adduct of a bisphenol; and a monopropylene oxide adduct of a bisphenol. One of these phenolic compounds A or two or more can be used. Among these, a hydroxyalkylphenol or a hydroxyalkyl cresol is preferably used, and a hydroxyalkylphenol is more preferably used.

In the case of producing the curable resin intermediate without using the phenolic compound having an alcoholic hydroxyl group, the unsaturated monobasic acid is reacted so that the amount of the acid group in the unsaturated monobasic acid is preferably from 0.6 to 1.4 mol, more preferably from 0.7 to 1.3 mol, and even more preferably from 0.8 to 1.1 mol per chemical equivalent (molar equivalent) of the epoxy group in the epoxy resin. Reaction in such a ratio makes it easier to improve the curability of the curable resin obtained from the curable resin intermediate and increases the storage stability of the curable resin.

For producing the curable resin intermediate using a phenolic compound having an alcoholic hydroxyl group, several methods are available, including a method in which an epoxy resin and an unsaturated monobasic acid are reacted, and then a phenolic compound having an alcoholic hydroxyl group is reacted; a method in which an unsaturated monobasic acid and a phenolic compound having an alcoholic hydroxyl group are together reacted with an epoxy resin; and a method in which an epoxy resin and a phenolic compound having an alcoholic hydroxyl group are reacted, and then an unsaturated monobasic acid is reacted. Any of these may be employed.

In the case of producing the curable resin intermediate using the phenolic compound having an alcoholic hydroxyl group, the unsaturated monobasic acid is reacted in an amount preferably of 0.5 to 0.85 mol, more preferably of 0.55 to 0.8 mol, and even more preferably of 0.6 to 0.75 mol per chemical equivalent (molar equivalent) of the epoxy group in the epoxy resin. Reacting the unsaturated monobasic acid in an amount of 0.5 mol or more per chemical equivalent of the epoxy group in the epoxy resin makes it easier to improve the curability of the resulting curable resin. Reacting the unsaturated monobasic acid in an amount of 0.85 mol or less per chemical equivalent of the epoxy group in the epoxy resin can reduce the brittleness of the resulting cured product and can further improve the ICT resistance of the resulting cured product.

In the case of producing the curable resin intermediate using the phenolic compound having an alcoholic hydroxyl group, the phenolic compound having an alcoholic hydroxyl group is reacted in an amount preferably of 0.15 to 0.5 mol, more preferably of 0.2 to 0.45 mol, and even more preferably of 0.25 to 0.4 mol per chemical equivalent (molar equivalent) of the epoxy group in the epoxy resin. Reacting the phenolic compound A in an amount 0.15 mol or more per chemical equivalent of the epoxy group in the epoxy resin can increase the flexibility of the resulting cured product. Reacting the phenolic compound A in an amount of 0.5 mol or less per chemical equivalent of the epoxy group in the epoxy resin makes it easier to improve the curability of the resulting curable resin.

The total amount of the unsaturated monobasic acid and the phenolic compound A is preferably from 0.8 to 1.1 mol and more preferably from 0.85 to 1.05 mol per chemical equivalent (molar equivalent) of the epoxy group in the epoxy resin. The unsaturated monobasic acid and the phenolic compound A in a total amount of 0.8 mol or more per chemical equivalent of the epoxy group in the epoxy resin makes it easier to sufficiently exhibit the effect of introducing the unsaturated monobasic acid and the phenolic compound A into the epoxy resin. On the other hand, the unsaturated monobasic acid and the phenolic compound A in a total amount of 1.1 mol or less per chemical equivalent of the epoxy group in the epoxy resin reduces the amounts of the unsaturated monobasic acid and the phenolic compound A remaining unreacted. Reducing the amounts of the unsaturated monobasic acid and the phenolic compound A remaining unreacted increases the storage stability of the resulting curable resin and can suppress deterioration of the properties of the resulting cured product.

In the production of the curable resin intermediate, the reaction of the epoxy resin with the unsaturated monobasic acid is carried out in the presence of benzene or naphthalene with two or more directly bonded hydroxy groups. Thus, the resulting curable resin intermediate contains benzene or naphthalene with two or more directly bonded hydroxy groups. In the reaction, the benzene or naphthalene with two or more directly bonded hydroxy groups functions as a polymerization inhibitor. In addition, in a curable resin composition containing the curable resin produced from the curable resin intermediate, benzene or naphthalene with two or more directly bonded hydroxy groups is present, Thus, this reduces the brittleness of the resulting cured product and further improves the ICT resistance of the resulting cured product. This effect is considered to be obtained by interaction of each of the at least two phenolic hydroxyl groups contained in the benzene or naphthalene with the curable resin backbone, which thus allows the benzene or naphthalene to act as a cushioning material between the curable resin backbones.

The benzene or naphthalene with two or more directly bonded hydroxy groups does not have a substituent other than a phenolic hydroxyl group and thus advantageously acts as a cushioning material between the curable resin backbones. In contrast, benzene or naphthalene having a substituent other than a phenolic hydroxyl group would have a poor effect as a cushioning material between the curable resin backbones. For example, in the case of using methylhydroquinone in the production of the curable resin intermediate, the steric hindrance of the methyl group contained in methylhydroquinone would make it difficult for either of the two phenolic hydroxy groups to interact with the curable resin backbone and reduce the effect as a cushioning material between the curable resin backbones.

Examples of the benzene or naphthalene with two or more directly bonded hydroxy groups include hydroquinone, catechol, 1,2,3-trihydroxybenzene, 1,2,4-trihydroxybenzene, 1,2-dihydroxynaphthalene, 1,4-dihydroxynaphthalene, 1,5-dihydroxynaphthalene, 26-dihydroxynaphthalene, and 1,3,8-trihydroxynaphthalene. One of these benzenes or naphthalenes, or two or more can be used. The benzene or naphthalene with two or more directly bonded hydroxy groups is preferably a quinone reduced form, such as hydroquinone, catechol, 1,2-dihydroxynaphthalene, 1,4-dihydroxynaphthalene, or 2,6-dihydroxynaphthalene; more preferably a quinone reduced form in which two hydroxy groups are not adjacent to each other, such as hydroquinone, 1,4-dihydroxynaphthalene, or 2,6-dihydroxynaphthalene; and particularly preferably hydroquinone.

The amount of the benzene and/or naphthalene with two or more directly bonded hydroxy groups is preferably from 0.001 to 1 mass % per 100 mass % of the epoxy resin. The amount is more preferably from 0.005 to 0.9 mass %, even more preferably from 0.01 to 0.7 mass %, and still more preferably from 0.05 to 0.5 mass %.

In the production of the curable resin intermediate, an additional polymerization inhibitor may be used in addition to the benzene or naphthalene with two or more directly bonded hydroxy groups. The additional polymerization inhibitor is not particularly limited, and a known polymerization inhibitor can be used. Examples of the additional polymerization inhibitor include methylhydroquinone, benzoquinone, hydroquinone monomethyl ether, p-tert-butylhydroquinone, 2,6-di-t-butyl-4-methylphenol, 6-t-butyl-2,4-dimethylphenol, 2,2′-methylenebis(4-methyl-6-t-butylphenol), p-tert-butylcatechol, N,N-diethylhydroxylamine, 1,1-diphenyl-2-picrylhydrazyl, tri-p-nitrophenylmethyl, phenothiazine, 2,2,6,6-tetramethylpiperidine 1-oxyl, and oxygen.

The amount of the additional polymerization inhibitor to be used is preferably 10 mass % or less, more preferably 5 mass % or less, even more preferably 1 mass % or less, and particularly preferably 0 mass % per 100 mass % of the total amount of the polymerization inhibitor including the benzene and naphthalene with two or more directly bonded hydroxy groups.

As described above, the curable resin intermediate can be obtained by a production method including reacting an epoxy resin having a polydispersity (Mw/Mn) of 2.8 or more with an unsaturated monobasic acid in the presence of benzene or naphthalene with two or more directly bonded hydroxy groups. In addition, the epoxy resin may be further reacted with a phenolic compound having an alcoholic hydroxyl group. In the case of reacting also a phenolic compound having an alcoholic hydroxyl group, either reaction of the epoxy resin with the unsaturated monobasic acid or with the phenolic compound having an alcoholic hydroxyl group may be carried out first, or the epoxy resin may be reacted with both simultaneously.

The reaction of the epoxy resin with an unsaturated monobasic acid and as necessary with a phenolic compound having an alcoholic hydroxyl group is carried out in the coexistence of a reaction catalyst usually preferably at 80° C. to 130° C. and more preferably at 90 to 120° C. In addition, the reaction may be carried out as necessary in the presence of a radically polymerizable compound or a diluent, such as a solvent, described later.

Examples of the reaction catalyst include a tertiary amine, such as triethylamine; a quaternary ammonium salt, such as triethylbenzylammonium chloride; an imidazole compound, such as 2-ethyl-4-methylimidazole; a phosphorus compound, such as triphenylphosphine; an organic acid salt or an inorganic acid salt of a metal (such as lithium chloride); or a chelate compound. The amount of the reaction catalyst to be used is not particularly limited and is, for example, preferably in a range of 0.0001 to 5.0 mass % and more preferably of 0.001 to 1.0 mass % per total mass of the reaction raw materials.

In the curable resin intermediate obtained by the production method according to an embodiment of the present disclosure, a hydroxyl group formed by ring-opening of an epoxy group by the reaction of the unsaturated monobasic acid with the epoxy group in the epoxy resin is present. Furthermore, in the case of reacting a phenolic compound having an alcoholic hydroxyl group, in addition to the hydroxy group, a hydroxyl group derived from the phenolic compound A and a hydroxyl group formed by ring-opening of the epoxy group by the reaction of the phenolic compound A with the epoxy group in the epoxy resin are present.

### 2. Curable Resin

A curable resin according to an embodiment of the present disclosure is a radically polymerizable curable resin obtained by modifying an epoxy resin. Specifically, the curable resin is obtained by reacting a polybasic acid anhydride with the curable resin intermediate that is a reaction product of the epoxy resin and an unsaturated monobasic acid. More specifically, it is obtained by a production method including reacting a polybasic acid anhydride with a hydroxyl group contained in the curable resin intermediate to introduce a carboxyl group. The curable resin obtained by the production method according to an embodiment of the present disclosure is an epoxy resin into which a radically polymerizable double bond and a carboxyl group are introduced. Thus, the curable resin has alkaline developability and curability by heat or light and can be used, for example, as an alkaline-developable curable resin for image formation and the like. In addition, using the curable resin according to an embodiment of the present disclosure can form a cured product with excellent adhesion and TCT resistance.

The polybasic acid anhydride is a compound with a plurality of acid groups anhydrified with each other and has one or more acid anhydride groups. Examples of the polybasic acid anhydride include a dibasic acid anhydride, such as phthalic anhydride, succinic anhydride, octenyl succinic anhydride, pentadodecenyl succinic anhydride, maleic anhydride, tetrahydrophthalic anhydride, hexahydrophthalic anhydride, methyl tetrahydrophthalic anhydride, 3,6-endomethylene tetrahydrophthalic anhydride, methyl endomethylene tetrahydrophthalic anhydride, tetrabromophthalic anhydride, and trimellitic acid; and an aliphatic or aromatic tetrabasic dianhydride, such as biphenyl tetracarboxylic dianhydride, diphenyl ether tetracarboxylic dianhydride, butanetetracarboxylic dianhydride, cyclopentanetetracarboxylic dianhydride, pyromellitic dianhydride, and benzophenonetetracarboxylic dianhydride. One of these polybasic acid anhydrides or two or more can be used. Among these, a dibasic acid anhydride is preferred, a dibasic acid anhydride having an ethylenically unsaturated double bond is more preferred, and a tetrahydrophthalic anhydride or maleic anhydride is even more preferred.

The polybasic acid anhydride is reacted so that the amount of the acid anhydride group in the polybasic acid anhydride is preferably from 0.1 to 1.1 mol and more preferably from 0.2 to 0.9 mol per chemical equivalent (molar equivalent) of the hydroxyl group in the curable resin intermediate. Reacting the polybasic acid anhydride in this manner can suitably introduce the carboxyl group into the resulting curable resin and can efficiently carry out the reaction of the polybasic acid anhydride with the curable resin intermediate.

As described above, the curable resin can be obtained by a production method including reacting the curable resin intermediate with the polybasic acid anhydride. The reaction of the curable resin intermediate and the polybasic acid anhydride is usually carried out in the presence of benzene or naphthalene with two or more directly bonded hydroxy groups preferably at 50° C. to 130° C. and more preferably at 70 to 110° C. In addition, the reaction may be carried out as necessary in the presence of a reaction catalyst and/or a radically polymerizable compound or a diluent, such as a solvent, described later. The reaction of the curable resin intermediate with the polybasic acid anhydride is conveniently carried out by adding the polybasic acid anhydride to the reaction solution following the reaction for producing the curable resin intermediate.

In the case of carrying out the reaction of the curable resin intermediate with the polybasic acid anhydride following the reaction for producing the curable resin intermediate, the benzene and/or naphthalene with two or more directly bonded hydroxy groups that is used in the production of the curable resin intermediate and in the reaction solution may continue to be used, or the benzene and/or naphthalene with two or more directly bonded hydroxy groups may be further added. From the viewpoint of convenience, it is preferred to continue to use the benzene and/or naphthalene with two or more directly bonded hydroxy groups that is used in the production of the curable resin intermediate. The amount of the benzene and/or naphthalene with two or more directly bonded hydroxy groups to be used in the reaction of the curable resin intermediate with the polybasic acid anhydride is preferably from 0.001 to 1 mass % per 100 mass % of the epoxy resin constituting the curable resin intermediate. The amount is more preferably from 0.005 to 0.9 mass %, even more preferably from 0.01 to 0.7 mass %, and still more preferably from 0.05 to 0.5 mass %.

Examples of the reaction catalyst include a tertiary amine, such as triethylamine; a quaternary ammonium salt, such as triethylbenzylammonium chloride; and a metal salt, such as lithium chloride. In the case of carrying out the reaction of the curable resin intermediate with the polybasic acid anhydride following the reaction for producing the curable resin intermediate, the reaction catalyst that is used in the production of the curable resin intermediate and in the reaction solution may continue to be used, or the reaction catalyst may be further added. From the viewpoint of convenience, it is preferred to continue to use the reaction catalyst used in the production of the curable resin intermediate. The amount of the reaction catalyst to be used in the reaction of the curable resin intermediate with the polybasic acid anhydride is not particularly limited and is, for example, preferably in a range of 0.0001 to 5.0 mass % and more preferably of 0.001 to 1.0 mass % per total mass of the reaction raw materials.

The reaction product obtained by reacting the curable resin intermediate with the polybasic acid anhydride is preferably filtered. That is, in an embodiment of the present disclosure, after reacting the curable resin intermediate with the polybasic acid anhydride to obtain a crude product, the crude product is preferably filtered (filtration step). Performing the filtration can remove insoluble matter (a contaminant) contained in the crude product, and the curable resin thus obtained can achieve good pattern accuracy in the use in image formation.

The filtration is performed using a known filter medium, such as a bag filter, a cartridge filter, or a stainless steel wire mesh, and a filter medium with resistance to a solvent or acid used is preferably used. The filtration may be performed at normal pressure, may be performed by pressurization on the primary side (inlet side) of the filter medium, or may be performed by reducing pressure on the secondary side (outlet side) of the filter medium, and a known filtration method can be employed. From the viewpoint of increasing the filtration accuracy, the pore size (opening) of the filter medium is preferably 100 μm or less and more preferably 50 μm or less, and from the viewpoint of ensuring filtration rate (productivity), the pore size is preferably 0.1 μm or more and more preferably 1 μm or more. That is, the pore size of the filter medium is preferably from 0.1 to 100 μm and more preferably from 1 to 50 μm. From the viewpoints of the working environment, safety, and productivity, the filtration temperature is preferably 20° C. or higher, more preferably 30° C. or higher, and preferably 100° C. or lower, more preferably 95° C. or lower. That is, the filtration temperature is preferably from 20 to 100° C. and more preferably from 30 to 95° C.

According to the method for producing a curable resin according to an embodiment of the present disclosure, the polybasic acid anhydride reacts with a hydroxyl group contained in the curable resin intermediate by reacting the polybasic acid anhydride with the curable resin intermediate, and thus a carboxyl group is introduced. A curable resin containing a carboxyl group is alkaline-developable, and thus the curable resin according to an embodiment of the present disclosure can be used as an alkaline-developable curable resin for image formation and the like. In particular, in the case of using the curable resin intermediate obtained by the production method including reacting the phenolic compound having an alcoholic hydroxyl group, the polybasic acid anhydride preferentially reacts with the hydroxyl group derived from the phenolic compound A. Thus, the double bond moiety introduced by the reaction with the unsaturated monobasic and the carboxyl group introduced by the reaction with the polybasic acid anhydride are present sufficiently apart from each other, and this allows each functional group to exhibit its function more effectively.

The curable resin according to an embodiment of the present disclosure contains:
an epoxy resin-derived moiety having a structure in which the epoxy group of an epoxy resin is ring-opened;
an unsaturated monobasic acid residue bonded to a carbon atom of the ring-opened moiety derived from the epoxy group; and
a polybasic acid anhydride residue bonded to an oxygen atom of the ring-opened moiety derived from the epoxy group. In the curable resin according to an embodiment of the present disclosure, a radically polymerizable double bond and a carboxyl group are introduced into the epoxy resin. Thus, the curable resin has alkaline developability and curability by heat or light. In addition, the polydispersity (Mw/Mn) of the epoxy resin-derived moiety is 2.8 or more. Thus, the curable resin can form a cured product with excellent adhesion and excellent TCT resistance, that is, excellent thermal shock resistance, as being less likely to crack even though a thermal history of high temperature and low temperature is repeatedly applied. Furthermore, the curable resin having a phenolic compound residue having an alcoholic hydroxyl group bonded to a carbon atom of the ring-opened moiety derived from the epoxy group and a structure in which the polybasic acid anhydride residue is bonded to an oxygen atom contained in the phenolic compound A has even better radical polymerizability and alkaline developability and can form a cured product with further improved adhesion and TCT resistance.

The acid value of the curable resin is preferably from 30 to 120 mg KOH/g, more preferably from 40 to 110 mg KOH/g, and even more preferably from 50 to 100 mg KOH/g. The curable resin with an acid value of 30 mg KOH/g or more makes it easier to exhibit good alkaline developability even in a weak alkaline aqueous solution. The curable resin with an acid value of 120 mg KOR/g or less makes the part exposed to light less likely to be eroded by an alkaline developer and improves the water resistance and moisture resistance of the resulting cured product.

The double bond equivalent (molecular weight per chemical equivalent of the radically polymerizable double bond) of the curable resin is preferably from 300 to 620 g/eq., more preferably from 330 to 610 g/eq., and even more preferably from 350 to 600 g/eq. Controlling the double bond equivalent of the curable resin together with the polydispersity (Mw/Mn) of the epoxy resin broadens the range of physical properties of the resulting cured product. The curable resin with a double bond equivalent of 300 g/eq. or more has improved curability and improves the thermal properties of the resulting cured product. The curable resin with a double bond equivalent of 620 g/eq. or less improves the flexibility of the resulting cured product.

The double bond equivalent of the curable resin is determined by dividing the total mass of the curable resin by the number of moles of the radically polymerizable double bonds introduced into the curable resin.

The curable resin preferably contains benzene or naphthalene with two or more directly bonded hydroxy groups. The content of the benzene and/or naphthalene with two or more directly bonded hydroxy groups in the curable resin is preferably from 0.0005 to 0.8 mass %, more preferably from 0.002 to 0.7 mass %, even more preferably from 0.005 to 0.6 mass %, and even more preferably from 0.02 to 0.4 mass % in 100 mass % of the curable resin.

### 3. Curable Resin Composition

The curable resin composition according to an embodiment of the present disclosure is a composition containing the curable resin described above and a polymerization initiator, and may further contain a monomer (in particular, a radically polymerizable monomer). The curable resin composition can be obtained by a production method including: producing a curable resin by the method for producing a curable resin according to an embodiment of the present disclosure; and blending the curable resin and a polymerization initiator (blending step). The curable resin composition can form a cured product by curing the curable resin by applying heat or by light irradiation. Using the curable resin composition according to an embodiment of the present disclosure can form a cured product with excellent adhesion and TCT resistance.

The curable resin according to an embodiment of the present disclosure can be thermally cured by using a known thermal polymerization initiator and is preferably photo-cured by adding a photopolymerization initiator from the viewpoint of making it possible to finely process the cured product and to form an image by photolithography. In this respect, a photopolymerization initiator is preferably used as the polymerization initiator.

As the thermal polymerization initiator, a known thermal polymerization initiator can be used, and examples include an organic peroxide, such as methyl ethyl ketone peroxide, benzoyl peroxide, dicumyl peroxide, t-butyl hydroperoxide, cumene hydroperoxide, t-butyl peroxyoctoate, t-butyl peroxybenzoate, and lauroyl peroxide; and an azo-based compound, such as azobis(isobutyronitrile). Only one of the above thermal polymerization initiators may be used, or two or more may be used in combination. For use in thermal polymerization, a curing accelerator may be used by mixing it in the resin composition, and representative examples of such a curing accelerator include cobalt naphthenate, cobalt octylate, or a tertiary amine.

The amount of the thermal polymerization initiator to be used is preferably from 0.05 mass % to 5 mass % per 100 mass % of the total of the curable resin and a radically polymerizable compound used as necessary.

As the photopolymerization initiator, a known photopolymerization initiator can be used, and examples include benzoin and its alkyl ether, such as benzoin, benzoin methyl ether, and benzoin ethyl ether; an acetophenone, such as acetophenone, 2,2-dimethoxy-2-phenylacetophenone, 1,1-dichloroacetophenone, and 4-(1-t-butyldioxy-1-methylethyl)acetophenone; an anthraquinone, such as 2-methylanthraquinone, 2-amylanthraquinone, 2-t-butylanthraquinone, and 1-chloroanthraquinone; a thioxanthone, such as 2,4-dimethylthioxanthone, 2,4-diisopropylthioxanthone, and 2-chlorothioxanthone; a ketal, such as acetophenone dimethyl ketal and benzyldimethyl ketal; a benzophenone, such as benzophenone, 4-(1-t-butyldioxy-1-methylethyl)benzophenone and 3,3′,4,4′-tetrakis(t-butyldioxycarbonyl) benzophenone; 2-methyl-1-[4-(methylthio)phenyl]-2-morpholino-propan−1-one and 2-benzyl-2-dimethylamino-1-(4-morpholinophenyt)-butanone-1; an acylphosphine oxide; and a xanthone. Only one of the above photopolymerization initiators may be used, or two or more may be used in combination.

The amount of the photopolymerization initiator to be used is preferably from 0.3 to 20 mass %, more preferably from 0.5 to 15 mass %, and even more preferably from 1 to 10 mass % per 100 mass % of the total of the curable resin and a radically polymerizable compound used as necessary.

The curable resin composition may contain a radically polymerizable compound. Thus, in the blending step, a radically polymerizable compound may be further blended in addition to the curable resin and the polymerization initiator. The radically polymerizable compound may have only one radically polymerizable double bond or may have two or more radically polymerizable double bonds. The radically polymerizable compound is involved in photopolymerization and can improve the properties of the resulting cured product or adjust the viscosity of the curable resin composition.

A preferred amount of the radically polymerizable compound to be used in the case of using the radically polymerizable compound is preferably 5 mass % or more, more preferably 10 mass % or more, and preferably 500 mass % or less, more preferably 100 mass % or less (that is, preferably from 5 to 500 mass % and more preferably from 10 to 100 mass %) per 100 mass % of the curable resin.

Examples of the radically polymerizable compound include a radically polymerizable oligomer and a radically polymerizable monomer. Examples of the radically polymerizable oligomer that can be used include an unsaturated polyester, epoxy acrylate, urethane acrylate, and polyester acrylate. Examples of the radically polymerizable monomer that can be used include an aromatic vinyl monomer, such as styrene, α-methylstyrene, α-chlorostyrene, vinyltoluene, divinylbenzene, diallyl phthalate, and diallyl benzenephosphonate; a vinyl ester monomer, such as vinyl acetate and vinyl adipate; a (meth)acrylic monomer, such as methyl (meth)acrylate, ethyl (meth)acrylate, butyl (meth)acrylate, p-hydroxyethyl (meth)acrylate, (2-oxo-1,3-dioxolan-4-yl)-methyl (meth)acrylate, (di)ethylene glycol di(meth)acrylate, propylene glycol di(meth)acrylate, trimethylolpropane di(meth)acrylate, trimethylolpropane tri(meth)acrylate, pentaerythritol tetra(meth)acrylate, dipentaerythritol hexa(meth)acrylate, and tri(meth)acrylate of tris(hydroxyethyl) isocyanurate; and triallyl cyanurate. These are appropriately selected according to the application and required properties of the curable resin, and one of these, or two or more can be used.

The curable resin composition may contain a solvent. Thus, in the blending step, a solvent may be further blended in addition to the curable resin and the polymerization initiator. Examples of the solvent include a hydrocarbon, such as toluene and xylene; a cellosolve, such as cellosolve and butyl cellosolve; a carbitol, such as carbitol and butyl carbitol; an ester, such as cellosolve acetate, methyl carbitol acetate, carbitol acetate (also referred to as ethyl carbitol acetate), butyl carbitol acetate, (di)propylene glycol monomethyl ether acetate, (di)methyl glutarate, (di)methyl succinate, and (di)methyl adipate; a ketone, such as methyl isobutyl ketone and methyl ethyl ketone; and an ether, such as (di)ethylene glycol dimethyl ether. The solvent used in an embodiment of the present disclosure is preferably an ester, more preferably methyl carbitol acetate, ethyl carbitol acetate, or butyl carbitol acetate, and even more preferably ethyl carbitol acetate. One of these solvents can be used, or two or more can be used by mixing, and an appropriate amount is used so that the curable resin composition has an optimum viscosity at the time of use.

The curable resin composition may further contain a known additive as necessary, including a filler, such as tale, clay, barium sulfate, or silica; a coloring pigment; an antifoaming agent; a coupling agent; a leveling agent; a sensitizer; a release agent; a lubricant; a plasticizer; an antioxidant; an ultraviolet absorber; a flame retardant; a polymerization inhibitor; or a thickener.

### 4. Cured Product

The present disclosure also includes a cured product obtained by curing the curable resin or the curable resin composition. The cured product according to an embodiment of the present disclosure can be obtained by a production method including: producing a curable resin composition by the method for producing a curable resin composition according to an embodiment of the present disclosure; and curing the curable resin composition (curing step). In the curing step, the curable resin composition or the curable resin contained in the curable resin composition can be cured by applying heat to the curable resin composition or by irradiating the curable resin composition with light.

In an embodiment of the present disclosure, alkaline development can be carried out by applying the curable resin onto a substrate, exposing it to light to obtain a cured coating film, and then dissolving the unexposed part in an alkaline solution. Examples of the alkali that can be used include an alkali metal compound, such as sodium carbonate, potassium carbonate, sodium hydroxide, and potassium hydroxide; an alkaline earth metal compound, such as calcium hydroxide; ammonia; and a water-soluble organic amine, such as monomethylamine, dimethylamine, trimethylamine, monoethylamine, diethylamine, triethylamine, monopropylamine, dimethylpropylamine, monoethanolamine, diethanolamine, triethanolamine, ethylenediamine, diethylenetriamine, dimethylaminoethyl methacrylate, and polyethyleneimine. One of these, or two or more can be used.

The curable resin or curable resin composition according to an embodiment of the present disclosure can also be used in the form of a dry film obtained by applying the curable resin or curable resin composition to a film, such as polyethylene terephthalate, in advance and drying, in addition to a method of directly applying the curable resin or curable resin composition in a liquid state to a substrate. In this case, the dry film is laminated on the substrate, and the film is peeled off before or after exposure to light. In addition, the cured product can also be obtained by a computer-to-plate (CTP) system, which has recently been widely used in the field of printing plate making, that is, a method in which a coating film is directly scanned and exposed with a laser beam according to digitized data to draw an image without using a patterning film at the time of exposure to light.

The cured product according to an embodiment of the present disclosure is obtained by curing the modified epoxy resin using the epoxy resin having a polydispersity (Mw/Mn) of 2.8 or more and thus has excellent adhesion and excellent thermal shock resistance as being less likely to crack even though a thermal history of high temperature and low temperature is repeatedly applied.

This application claims the benefit of priority based on JP 2022-109176 B filed on Jul. 6, 2022. The entire contents of the specification of JP 2022-109176 B filed on Jul. 6, 2022 are incorporated herein for reference.

### EXAMPLES

Hereinafter, the present disclosure will be described in more detail by showing examples. However, the scope of the present disclosure is not limited to these examples, and all modifications made without departing from the gist of the present disclosure are included in the technical scope of the present disclosure. In the following description, “parts” represents “parts by mass” and “%” represents “mass %” unless otherwise specified.

In addition, the weight-average molecular weight (Mw), number-average molecular weight (Mn), and polydispersity (Mw/Mn) of epoxy resins used in synthesis examples were determined by gel permeation chromatography (GPC) measurement using polystyrene as a standard substance. The measurement conditions were as follows.
Instrument: gel permeation chromatography instrument HLC-8320GPC (available from Tosoh Corporation)
Column: TSKgel Super HZM-M (available from Tosoh Corporation)
Detector: RI detector for liquid chromatogram
Measurement temperature: 40° C.
Solvent: tetrahydrofuran (THF)
Sample concentration: 0.05 g/10 cc
Sample side flow rate: 0.6 mL/min

### (1) Synthesis of Curable Resin Intermediates and Curable Resins

### (1-1) Synthesis Example 1

In 196.5 parts of ethyl carbitol acetate, 208 parts of an ortho-cresol novolac type epoxy resin (cas. 29690-82-2; epoxy resin 1) with a polydispersity of 2.87 (Mn=1330, Mw=3820), a softening point of 91° C., and an epoxy equivalent of 208 g/eq. was dissolved, 1.4 parts of triphenylphosphine as a reaction catalyst and 0.6 parts of hydroquinone as a polymerization inhibitor were used, and 72.8 parts of acrylic acid as an unsaturated monobasic acid was added. The mixture was reacted at 110° C. for 15 hours, and a curable resin intermediate 1 was obtained. Then, 84.1 parts of tetrahydrophthalic anhydride was added as a polybasic acid anhydride and reacted with the curable resin intermediate 1 at 100° C. for 8 hours. The temperature of the resulting reaction liquid was reduced to 90° C., and the solution was filtered using a 300-mesh stainless steel wire mesh (opening of about 50 μm). As a result, an ethyl carbitol acetate solution (A-1) containing 65% of a curable resin 1 with an acid value of 90 mg KOH/g and a double bond equivalent of 360 g/eq. was obtained.

The curable resin 1 has structural units (1) and (2) below.

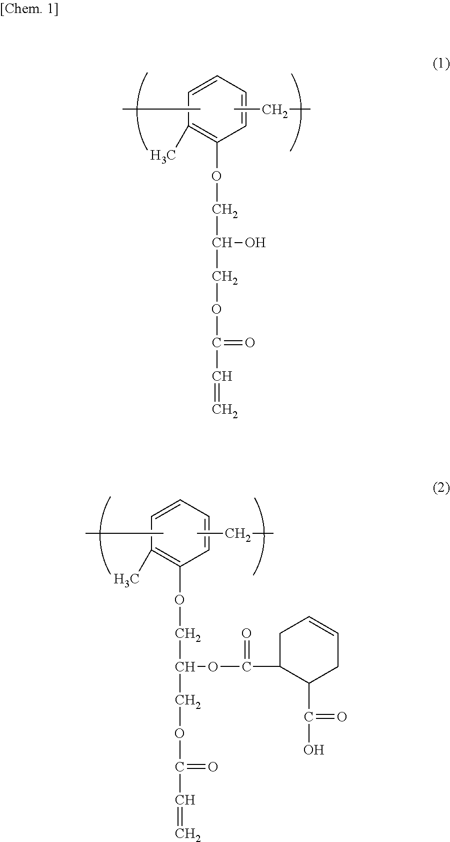

### (1-2) Synthesis Example 2

In 196.5 parts of ethyl carbitol acetate, 208 parts of an ortho-cresol novolac type epoxy resin (cas. 29690-82-2; epoxy resin 2) with a polydispersity of 3.03 (Mn=1270, Mw=3850), a softening point of 94° C., and an epoxy equivalent of 208 g/eq. was dissolved, 1.4 parts of triphenylphosphine as a reaction catalyst and 0.6 parts of hydroquinone as a polymerization inhibitor were used, and 72.8 parts of acrylic acid as an unsaturated monobasic acid was added. The mixture was reacted at 110° C. for 15 hours, and a curable resin intermediate 2 was obtained. Then, 84.1 parts of tetrahydrophthalic anhydride was added as a polybasic acid anhydride and reacted with the curable resin intermediate 2 at 100° C. for 8 hours. The temperature of the resulting reaction liquid was reduced to 90° C., and the solution was filtered using a 300-mesh stainless steel wire mesh (opening of about 50 m). As a result, an ethyl carbitol acetate solution (A-2) containing 65% of a curable resin 2 with an acid value of 91 mg KOH/g and a double bond equivalent of 360 g/eq. was obtained. The curable resin 2 has structural units (1) and (2) above.

### (1-3) Synthesis Example 3

In 196.5 parts of ethyl carbitol acetate, 208 parts of the ortho-cresol novolac type epoxy resin (epoxy resin 2) used in Synthesis Example 2 was dissolved, 1.5 parts of triphenylphosphine as a reaction catalyst and 0.6 parts of hydroquinone as a polymerization inhibitor were used, and 41.5 parts of p-hydroxyphenyl-2-ethanol as a phenolic compound having an alcoholic hydroxyl group and 51.2 parts of acrylic acid as an unsaturated monobasic acid were added. The mixture was reacted at 110° C. for 15 hours, and a curable resin intermediate 3 was obtained. Then, 64.3 parts of tetrahydrophthalic anhydride was added as a polybasic acid anhydride and reacted with the curable resin intermediate 3 at 100° C. for 5 hours. The temperature of the resulting reaction liquid was reduced to 90° C., and the solution was filtered using a 300-mesh stainless steel wire mesh (opening of about 50 μm). As a result, an ethyl carbitol acetate solution (A-3) containing 65% of a curable resin 3 with an acid value of 69 mg KOH/g and a double bond equivalent of 520 g/eq. was obtained.

The curable resin 3 has structural units (1), (2), and (3) below.

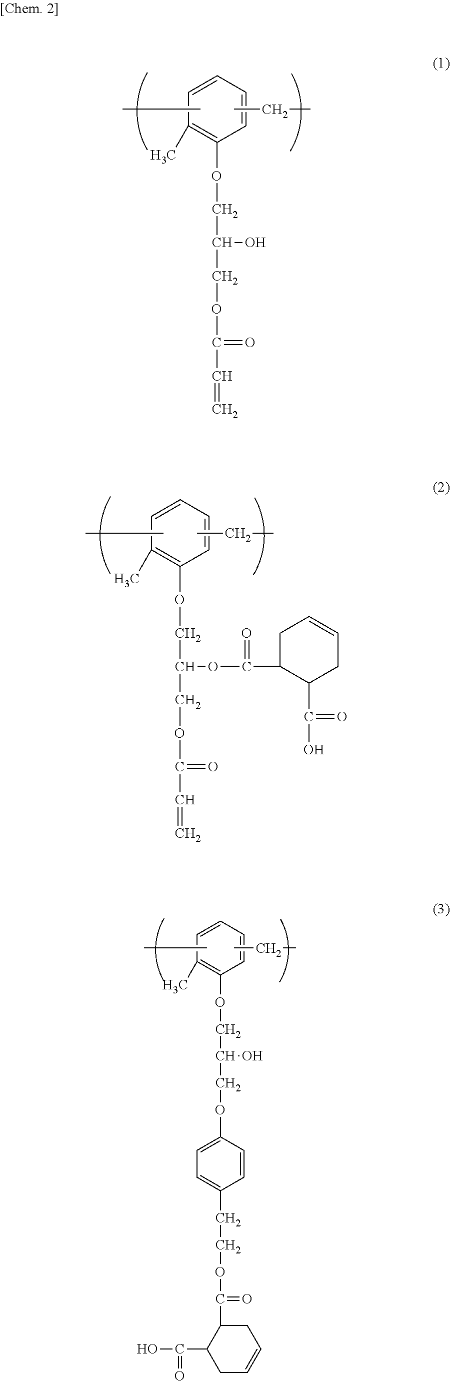

### (1-4) Synthesis Example 4

In 192.9 parts of ethyl carbitol acetate, 203 parts of an ortho-cresol novolac type epoxy resin (cas. 29690-82-2; epoxy resin 3) with a polydispersity of 2.92 (Mn=1100, Mw=3210), a softening point of 85° C., and an epoxy equivalent of 203 g/eq. was dissolved, 1.4 parts of triphenylphosphine as a reaction catalyst and 0.6 parts of hydroquinone as a polymerization inhibitor were used, and 72.8 parts of acrylic acid as an unsaturated monobasic acid was added. The mixture was reacted at 110° C. for 15 hours, and a curable resin intermediate 4 was obtained. Then, 82.6 parts of tetrahydrophthalic anhydride was added as a polybasic acid anhydride and reacted with the curable resin intermediate 4 at 100° C. for 8 hours. The temperature of the resulting reaction liquid was reduced to 90° C., and the solution was filtered using a 300-mesh stainless steel wire mesh (opening of about 50 μm). As a result, an ethyl carbitol acetate solution (A-4) containing 65% of a curable resin 4 with an acid value of 91 mg KOH/g and a double bond equivalent of 360 g/eq. was obtained. The curable resin 4 has structural units (1) and (2) above.

### (1-5) Comparative Synthesis Example 1

In 196.5 parts of ethyl carbitol acetate, 208 parts of the ortho-cresol novolac type epoxy resin (epoxy resin 1) used in Synthesis Example 1 was dissolved, 1.4 parts of triphenylphosphine as a reaction catalyst and 0.6 parts of methylhydroquinone as a polymerization inhibitor were used, and 72.8 parts of acrylic acid as an unsaturated monobasic acid was added. The mixture was reacted at 110° C. for 15 hours, and a curable resin intermediate 5 was obtained. Then, 84.1 parts of tetrahydrophthalic anhydride was added as a polybasic acid anhydride and reacted with the curable resin intermediate 5 at 100° C. for 8 hours. The temperature of the resulting reaction liquid was reduced to 90° C., and the solution was filtered using a 300-mesh stainless steel wire mesh (opening of about 50 μm). As a result, an ethyl carbitol acetate solution (B-1) containing 65% of a curable resin 5 with an acid value of 89 mg KOH/g and a double bond equivalent of 360 g/eq. was obtained. The curable resin 5 has structural units (1) and (2) above.

### (1-6) Comparative Synthesis Example 2

In 197.2 parts of ethyl carbitol acetate, 209 parts of an ortho-cresol novolac type epoxy resin (cas. 29690-82-2; epoxy resin 4) with a polydispersity of 2.72 (Mn=1340, Mw=3640), a softening point of 92.5° C., and an epoxy equivalent of 209 g/eq. was dissolved, 1.4 parts of triphenylphosphine as a reaction catalyst and 0.6 parts of hydroquinone as a polymerization inhibitor were used, and 72.8 parts of acrylic acid as an unsaturated monobasic acid was added. The mixture was reacted at 110° C. for 15 hours, and a curable resin intermediate 6 was obtained. Then, 84.4 parts of tetrahydrophthalic anhydride was added as a polybasic acid anhydride and reacted at 100° C. for 8 hours. The temperature of the resulting reaction liquid was reduced to 90° C., and the solution was filtered using a 300-mesh stainless steel wire mesh (opening of about 50 μm). As a result, an ethyl carbitol acetate solution (B-2) containing 65% of a curable resin 6 with an acid value of 90 mg KOH/g and a double bond equivalent of 370 g/eq. was obtained. The curable resin 6 has structural units (1) and (2) above.

### (1-7) Comparative Synthesis Example 3

In 199.3 parts of ethyl carbitol acetate, 212 parts of an ortho-cresol novolac type epoxy resin (cas. 29690-82-2; epoxy resin 5) with a polydispersity of 2.59 (Mn=1380. Mw=3570), a softening point of 94° C., and an epoxy equivalent of 212 g/eq. was dissolved, 1.4 parts of triphenylphosphine as a reaction catalyst and 0.6 parts of hydroquinone as a polymerization inhibitor were used, and 72.8 parts of acrylic acid as an unsaturated monobasic acid was added. The mixture was reacted at 110° C. for 15 hours, and a curable resin intermediate 7 was obtained. Then, 85.3 parts of tetrahydrophthalic anhydride was added as a polybasic acid anhydride and reacted with the curable resin intermediate 7 at 100° C. for 8 hours. The temperature of the resulting reaction liquid was reduced to 90° C., and the solution was filtered using a 300-mesh stainless steel wire mesh (opening of about 50 μm). As a result, a comparative ethyl carbitol acetate solution (B-3) containing 65% of a curable resin 7 with an acid value of 91 mg KOH/g and a double bond equivalent of 370 g/eq. was obtained. The curable resin 7 has structural units (1) and (2) above.

### (2) Preparation and Evaluation Methods of Curable Resin Compositions

### (2-1) Preparation Method

Curable resin compositions were prepared using each curable resin solution obtained in Synthesis Examples 1 to 4 and Comparative Synthesis Examples 1 to 3 according to the blending compositions listed in Table 1 and evaluated each as Examples 1 to 4 and Comparative Examples 1 to 3 by the following methods.

### Evaluation of Tack-Free Properties

Each curable resin composition was applied in a thickness of 20 to 30 μm onto a 0.5-mm thick copper plate and dried in a hot air circulation drying oven at 80° C. for 30 minutes, and a coating film was obtained. Then, a negative film was pressed onto the coating film and exposed to light at 2 J/cm² using an ultraviolet light exposure apparatus. After exposure to light, the state when the negative film was peeled off was evaluated according to the following criteria.
⊚: The negative film can be peeled off without making a peeling sound
∘: A slight peeling sound is made, but no trace of the negative film remains on the coating film
x: A peeling sound is made, and a trace of the negative film remains on the coating film.

### Evaluation of Developability

Each curable resin composition was applied in a thickness of 20 to 30 μm onto a 0.5-mm thick copper plate and dried in a hot air circulation drying oven at 80° C. for 30 minutes, and a coating film was obtained. Then, a negative film was pressed onto the coating film and exposed to light at 2 J/cm² using an ultraviolet light exposure apparatus. The negative film was peeled off, development was carried out at 30° C. for 80 seconds using a 1% Na₂CO₃ aqueous solution, and the presence of the remaining resin coating film was visually evaluated according to the following criteria.
∘: Good developability (no deposit at all on the unexposed part)
x: Poor developability (a deposit remains on the unexposed part)

### Evaluation of Adhesion

A dry coating film was formed in the same manner as in the evaluation of tack-free properties and exposed to light at 2 J/cm² using an ultraviolet light exposure apparatus. Then, heating was performed at a high temperature condition of 150° C. for 30 minutes. Thereafter, an adhesive tape was attached to the coating film so that the size of the attached surface was 24 mm×30 mm, and a peeling test was performed by momentarily peeling off the tape while the end of the tape was kept at right angles to the coating film surface, and the adhesion was visually evaluated according to the following criteria.
⊚: The coating film has good adhesion (no peeling)
∘: Less than 20% of the coating film (attached surface) is peeled off
x: 20% or more of the coating film (adhesion surface) is peeled off

### Thermal Cycle Test Resistance (TCT Resistance Evaluation)

A dry coating film was formed, exposed to light, and developed in the same manner as in the evaluation of developability, and a cured product was obtained. This was heated at 150° C. for 1 hour, and a test substrate was formed. Using this test substrate, a thermal cycle test was performed with one cycle of 15 minutes at −65° C. and 15 minutes at 150° C., and the appearance was observed every 100 cycles and visually evaluated according to the following criteria.
⊚: No crack is observed even when 200 cycles are performed
◯: A crack is observed at the time of performing 200 cycles
x: A crack is observed at the time of performing 100 cycles

### (3) Results

The test evaluation results of the curable resin compositions are listed in Table 1. In Examples 1 to 4, in which an ortho-cresol novolac type epoxy resin having a polydispersity of 2.8 or more was used as the epoxy resin and benzene with two or more directly bonded hydroxy groups was used as the polymerization inhibitor, the resulting cured products had excellent adhesion and thermal cycle test resistance (TCT resistance) and also had excellent tack-free properties and developability. In Example 3, in which p-hydroxyphenyl-2-ethanol was added as the phenolic compound having an alcoholic hydroxyl group, the adhesion and thermal cycle test resistance (TCT resistance) were further improved. On the other hand, in Comparative Example 1, in which methylhydroquinone was used as the polymerization inhibitor, the resulting cured product had poor tack-free properties and thermal cycle test resistance (TCT resistance). In addition, in Comparative Examples 2 and 3, in which an ortho-cresol novolac type epoxy resin having a polydispersity of less than 2.8 was used, the resulting cured products had poor adhesion and thermal cycle test resistance (TCT resistance), and in Comparative Example 2, the resulting cured product also had poor tack-free properties.

TABLE 1

| | | | | Polymerization | | | | |
|---|---|---|---|---|---|---|---|---|
| | | | Monomer | initiator | | | | |
| | Curable resin solution | | Blending | Blending | | | | |
| | | Blending amount | amount | amount | Tack-free | | | TCT |
| | Type | (parts) | (parts) | (parts) | properties | Developability | Adhesion | resistance |
| Example 1 | A-1 | 154 | 10 | 5 | ⊚ | ∘ | ∘ | ∘ |
| Example 2 | A-2 | 154 | 10 | 5 | ⊚ | ∘ | ∘ | ∘ |
| Example 3 | A-3 | 154 | 10 | 5 | ⊚ | ∘ | ⊚ | ⊚ |
| Example 4 | A-4 | 154 | 10 | 5 | ∘ | ∘ | ∘ | ∘ |
| Comparative | B-1 | 154 | 10 | 5 | x | ∘ | ∘ | x |
| Example 1 | | | | | | ∘ | | |
| Comparative | B-2 | 154 | 10 | 5 | x | ∘ | x | x |
| Example 2 | | | | | | ∘ | | |
| Comparative | B-3 | 154 | 10 | 5 | ⊚ | ∘ | x | x |
| Example 3 | | | | | | ∘ | | |

* Monomer (radically polymerizable compound); dipentaerythritol hexaacrylate Polymerization initiator; Irgacure (trade name) 907 (photopolymerization initiator available from BASF Japan Ltd.)

### INDUSTRIAL APPLICABILITY

The curable resin intermediate, the curable resin, and the curable resin composition of the present disclosure can be suitably used as an alkaline-developable image formation application in various applications, such as, for example, for printing plate making and production of a liquid crystal display panel, such as a protective film of a color filter, a color filter, and a black matrix.

1. A method for producing a curable resin intermediate, the method comprising reacting an epoxy resin having a polydispersity (Mw/Mn) of 2.8 or more with an unsaturated monobasic acid in the presence of benzene or naphthalene with two or more directly bonded hydroxy groups.

2. The production method according to claim 1, wherein the epoxy resin is a cresol novolac type epoxy resin.

3. The production method according to claim 1, wherein the epoxy resin has a weight-average molecular weight of 3000 or more, a softening point of 85 to 110° C., and an epoxy equivalent of 150 to 300 g/eq.

4. The production method according to claim 1, wherein in the reacting the epoxy resin with the unsaturated monobasic acid, the epoxy resin is also reacted with a phenolic compound having an alcoholic hydroxyl group.

5. A method for producing a curable resin, the method comprising producing a curable resin intermediate by the method described in claim 1, and then reacting the resulting curable resin intermediate with a polybasic acid anhydride.

6. The production method according to claim 5, wherein the curable resin has a double bond equivalent of 300 to 620 g/eq.

7. The production method according to claim 5, wherein the curable resin has an acid value of 50 to 100 mg KOH/g.

8. A method for producing a curable resin composition, the method comprising producing a curable resin by the production method described in claim 5, and then blending the resulting curable resin and a polymerization initiator, and as necessary a monomer.

9. A method for producing a cured product, the method comprising producing a curable resin composition by the production method described in claim 8, and then curing the resulting curable resin composition.

10. A curable resin comprising:
an epoxy resin-derived moiety having a structure in which an epoxy group of the epoxy resin is ring-opened;
an unsaturated monobasic acid residue bonded to a carbon atom of the ring-opened moiety derived from the epoxy group; and
a polybasic acid anhydride residue bonded to an oxygen atom of the ring-opened moiety derived from the epoxy group, wherein
the epoxy resin-derived moiety has a polydispersity (Mw/Mn) of 2.8 or more, and
the curable resin contains benzene or naphthalene with two or more directly bonded hydroxy groups.
